(19) United States
(12) Patent Application Publication
(10) Pub. No.: US 2007/0163144 A1
(43) Pub. Date: Jul. 19, 2007

(54) Laundry drier

(76) Inventors: Lothar Dittmer, Berlin (DE); Thomas Nawrot, Berlin (DE); Andreas Ziemann, Potsdam (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(21) Appl. No.: 10/557,363

(22) PCT Filed: May 13, 2004
(86) PCT No.: PCT/EP04/05149

§ 371 Date: Nov. 14, 2006

(30) Foreign Application Priority Data
May 23, 2003 (DE) 10323494.2

(51) Int. Cl. F26B 25/00; F26B 11/02

(52) U.S. Cl. 34/602; 34/242

(57) ABSTRACT

A program-controlled laundry drier equipped with a rotary drum in which the material to be dried is inserted and moved during the drying process. The dryer comprising a heater for heating the drying air and a blower which guides the drying air stream into the interior of the drum. The axis of a current generator is mechanically coupled to the rotary drum and the output voltage of the current generator is applied to the excitation winding of a relay whose switching contacts switch the heating current circuit for the drying air.

The invention relates to a laundry drier with a rotating drum.

U.S. Pat. No. 4,720,925 discloses a laundry drier comprising a horizontally arranged rotating drum, an inlet opening for process air on the rearward face of the drum and an outlet for process air which is arranged in the lower section of the bearing plate underneath a charging opening for clothing. The outlet opening is arranged in a sloping section of the bearing plate and is covered with a grid.

A disadvantage with this arrangement is that items of clothing can come to rest on the outlet grid since an underpressure prevails in the area of the outlet grid. This occurs particularly when the drum has a minimum load, and as the degree of drying of the laundry increases and when drying easy-care laundry since the laundry which is then lighter is entrained further and only detaches from the drum and drops down at a late stage. The fall curve can be so wide that the laundry only drops down in the other half of the drum and is pulled over the grid of the outlet opening by the rotational movement of the drum which results in short-term hindrance of air passage through the grid. This non-steady flow hindrance or pulsation of the flow produces noises and results in longer drying times because of the reduced air throughput.

It is the object of the invention to provide a drier which ensure a flow of process air through the drum which is as unperturbed as possible.

This object is solved by a drier having the features of claim 1. Since the laundry drier has a projection before the outlet opening in the principal direction of rotation, the laundry which falls in front of the outlet opening in the direction of rotation and is entrained by the movement of the drum is guided away from the outlet opening so that the outlet opening is not covered by items of laundry. The projection thus serves to deflect the laundry from the outlet opening. In this case, the projection is preferably arranged so that the laundry is returned into the interior of the drum. The arrangement thus ensures an improved flow of process air through the drum which means a shortening of the drying time. Furthermore, this arrangement significantly reduces the development of noise, especially with minimum loading since the laundry is kept away from the outlet opening. In addition, hazardous situations such as overheating are avoided.

The arrangement is especially advantageous if the outlet opening is arranged on an annular housing section which is located between a laundry charging opening which can be closed by a door and the front open face of the drum. It is especially advantageous if the outlet opening covered by a grid is arranged on a lower section of the annular housing section which is constructed as descending towards the drum.

Since the projection is constructed as a wedge-shaped body which has a guiding wall which rises progressively from the annular housing section before the outlet opening in the principal direction of rotation and extends as far as the outlet opening and which has a front wall which descends steeply from the guiding wall towards the outlet opening, laundry which falls on the annular housing section before the outlet opening in the direction of rotation is conveyed back into the interior of the drum by the rotational movement and prevented from at least partly closing the outlet opening. It is especially advantageous if the projection is made to emerge from the annular housing section at the height of half the diameter of the drum and is made to rise in a sickle shape as far as the outlet opening and descend steeply in front of the outlet opening.

Since the front wall of the projection has an opening which is connected to an outlet channel arranged downstream of the outlet opening, process air can additionally flow unhindered via this opening, which measurably improves the overall air throughput.

It is furthermore advantageous if the annular housing section is constructed as a bearing plate between the charging opening and the drum, on which elements for mounting the front end of the drum are provided.

It is furthermore possible to rotate the drum in a direction of rotation opposite to the principal direction of rotation if a tangle of laundry can be released thereby for example or the heating time can be shortened. In the case of a laundry drier which has a so-called reversing drum, it can thus be advantageous if one projection is arranged symmetrically to the outlet opening on both sides of the outlet opening. The advantageous effect of deflecting the laundry is thus achieved in each direction of rotation.

Since the inside of the door has an additional projection which projects adjacent to the outlet opening further into the interior of the drum than on a section of the door remote from the outlet opening, this additional projection acts as a laundry deflector which keeps the falling laundry away from the outlet opening and conveys it back into the drum. This mode of action is intensified if the additional projection seen in the principal direction of rotation projects further into the interior of the drum at the end of the additional projection than at the beginning of the additional projection.

Further features and advantages of the invention are obtained from the following description of an exemplary embodiment with reference to the appended drawings.

In the figures:

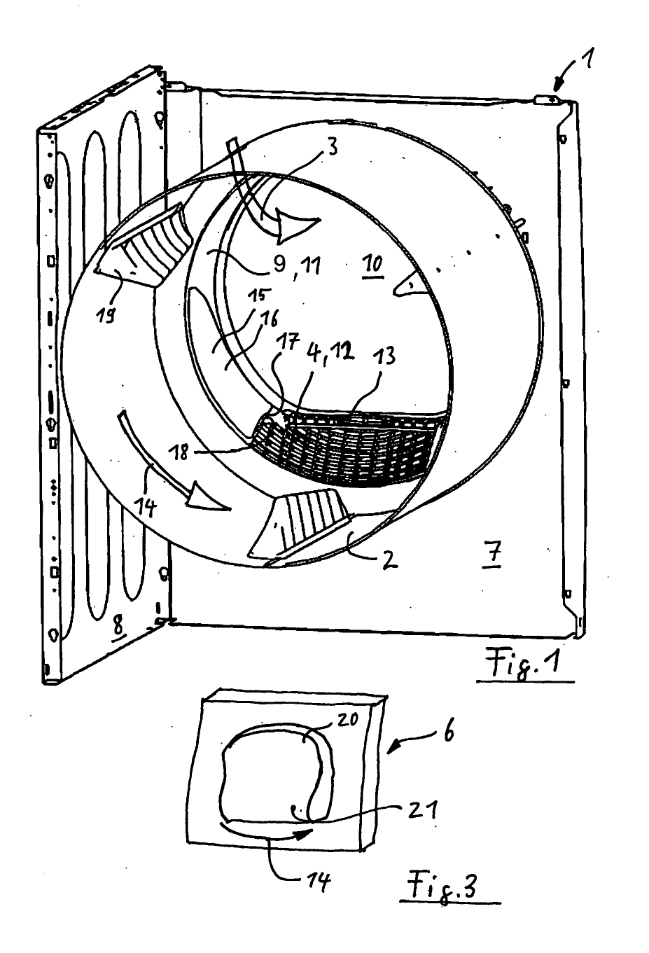

FIG. 1 is a cutaway oblique view of a laundry drier from the inside of the drum towards the charging opening;

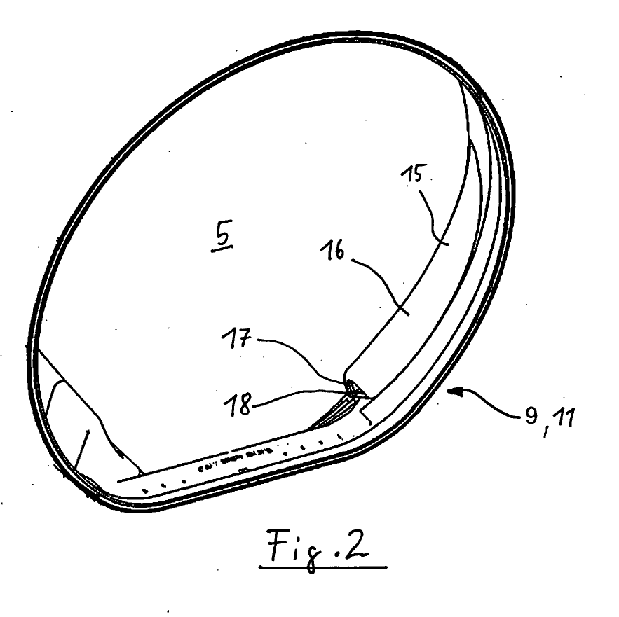

FIG. 2 is an oblique view of the bearing plate used in FIG. 1 viewed from the outside into the charging opening;

FIG. 3 is an oblique view of the inside of a door for closing the charging opening of a laundry drier from FIG. 1.

According to FIG. 1, a drier has a housing 1, a substantially horizontally arranged drum, an inlet opening 3 for warm process air in the drum and an outlet opening for process air from the drum, a charging opening 5 for laundry on the front of the drum 2 and a door 6 (FIG. 3) for closing the charging opening 5.

The inlet opening 3 is arranged in a middle section of the rear face of the drum 2 (the rear face of the drum 2 is cut away in FIG. 1 and thus cannot be seen). The housing 1 has a front plate 7 on which the door 6 is fixed, two side plates 8 (only one is shown) and an annular body 9 which is arranged between the charging opening 5 and the front open face 10. Since the front end of the drum 2 is mounted on the annular body 9, the annular body 9 is also designated as bearing plate 11. Located on a lower section of the annular body 9 or the bearing plate 11 is the outlet opening 4 for process air which is covered by a grid 12. Located underneath the grid is an outlet channel (not shown) which is connected to the suction side of a fan (not shown). Provided adjacent to the grid 12 on the bearing plate 11 is a lint filter 13 which can be inserted into the outlet channel. The lower section of the bearing plate 11 on which the outlet opening 4 is arranged is constructed as sloping steeply from the charging opening 5 towards the front of the drum. The drum 2 which can be arranged so that it slopes downwards from the horizontal at the back with a preferred angle of inclination of 1°-35° has a principal direction of rotation 14 (arrow).

A projection 15 is arranged on the bearing plate 11 constructed as annular body 9 before the outlet opening 4 in the principal direction of rotation 14. The projection 15 is constructed as a wedge-shaped body having a guiding wall 16 and a front wall 17. The guiding wall 16 rises from the bearing plate beginning approximately at half the height of the drum and rises increasingly towards the edge of the outlet opening 4 and at this point descends steeply towards the annular body 9, approximately at right angles to the surface of the annular body 9. In other words, the projection 15 emerges from the annular body 9 at the height of half the diameter of the drum and rises increasingly in a sickle shape towards the outlet opening 4 (FIG. 1 and FIG. 2). Located on the front wall 17 of the projection 15 is an opening 18 which is connected to the outlet channel (not shown). When the drum rotates in the principal direction of rotation 14, the laundry is entrained by the entraining device 19 and depending on the rotational speed and also on the degree of moisture of the laundry (weight of the laundry), seen in the principal direction of rotation 14, detaches from the outer surface of the drum 2 approximately in an area of +/−70° and drops downwards. Laundry which falls onto the section of the bearing plate 11 arranged in the principal direction of rotation 14 before the outlet opening or the grid 12 is guided towards the inside of the drum 2 on the one hand and guided over the grid 12 on the other hand. In this way the projection 15 acts as a laundry deflector which deflects the laundry away from the grid 12 into the drum. This effectively reduces the suction or resting of the laundry onto the grid 12 at which an underpressure prevails. The laundry is especially always kept at a distance from the grid 12 by the front wall 17 of the projection 15 which reduces the frequency of sucked-on laundry. If the laundry is sucked onto the grid 12, the duration of suction of laundry onto the grid 12 is shortened by the projection 15. This avoids perturbations in the conveyance of process air through the drying compartment constructed as the drum 2 which results in an increased air throughput through the drying compartment and therefore shorter drying times. In addition, noise caused by suction of laundry onto the outlet opening 4 or the grid 12 is effectively reduced. It is especially advantageous if process air can additionally flow via the opening 18 arranged in the front wall 17 since this opening lies in the “shade” of the projection 15 and thus is almost never covered by laundry.

FIG. 3 shows an inner view of the door 6 which has a body 20 projecting into the charging opening 5. This body 20 has an additional projection 21 which, when the door 6 is closed, projects adjacent to the outlet opening 4 further into the interior of the drum 2 than at a section emote from the outlet opening 4. It is especially advantageous if the additional projection 21 seen in the principal direction of rotation 14, projects further into the interior of the drum 2 at the end of the additional projection 21 than at the beginning of the additional projection 21. This additional projection 21 serves as a laundry deflector similar to the projection 15 so that the laundry falling from the top of the drum 2 is guided into the interior of the drum and does not fall on the grid 12 and become sucked thereon.

The preceding embodiment is primarily designed for operation of the laundry drier in the principal direction of rotation 14. However, driers are also available which operate in the so-called reversing mode to reduce the heating time for example or to improve the distribution of the laundry inside the drum. In a laundry drier operating in the reversing mode, a projection 15 can be arranged symmetrically to the outlet opening 4 on both sides of the outlet opening 14.

1-11. (canceled)

12. A laundry drier comprising:
a housing;
a drum rotating in a principal rotational direction within the housing and forming a drying chamber for laundry;
an inlet opening for process air in the drum;
an outlet opening for process air from the drum; and
a projection arranged in the principal direction of rotation before the outlet opening for deflecting the laundry from the outlet opening.

13. The laundry drier according to claim 12, further comprising a charging opening for the laundry which may be closed by means of a door, is arranged on the housing on the front open face of the drum and that the housing has an annular housing section between the charging opening and the drum on which the outlet opening is arranged, which opening is in turn covered by a grid.

14. The laundry drier according to claim 13, wherein the annular housing section has a lower section which decreases from the charging opening towards the drum on which the outlet opening is constructed.

15. The laundry drier according to claim 13, wherein the projection is constructed as a wedge-shaped body which has a guiding wall which rises progressively from the annular housing section before the outlet opening in the principal direction of rotation and extends as far as the outlet opening and which has a front wall which descends steeply from the guiding wall towards the outlet opening.

16. The laundry drier according to claim 13, wherein the projection emerges from the annular housing section at the height of half the diameter of the drum and rises in a sickle shape as far as the outlet opening increasingly towards the annular housing section.

17. The laundry drier according to claim 12, wherein the projection has an opening adjacent to the outlet opening which is connected to an outlet channel arranged downstream of the outlet opening.

18. The laundry drier according to claim 13, wherein the annular housing section is constructed as a bearing plate between the charging opening and the drum, on which elements for mounting the front end of the drum are provided.

19. The laundry drier according to claim 12, wherein the drum can also be rotated in a direction of rotation opposite to the principal direction of rotation.

20. The laundry drier according to claim 19, wherein the projection includes two projections arranged symmetrically to the outlet opening on both sides of the outlet opening.

21. The laundry drier according to claim 12, wherein the inside of the door adjacent to the outlet opening has an additional projection which projects into the interior of the drum adjacent to the outlet opening.

22. The laundry drier according to claim 21, wherein the additional projection seen in the principal direction of rotation projects further into the interior of the drum at the end of the additional projection than at the beginning of the additional projection.

23. A laundry drier comprising:
a housing;
a drum supported by the housing for rotation with respect to the housing in a principal rotational direction and forming a drying chamber;
an opening in fluid flow communication with the drying chamber; and
a projection extending radially inwardly from the housing and disposed adjacent the opening for deflecting the laundry away from the opening.

24. The laundry drier according to claim 23, wherein the housing includes an annular housing section fixed with respect to the housing and surrounding a charging opening providing access to the drum, the projection being connected to the annular housing section and extending radially inwardly from the annular housing section.

25. The laundry drier according to claim 24, wherein the projection is integrally formed with the annular housing section.

26. The laundry drier according to claim 24, wherein the projection includes a guiding wall steadily extending from the annular housing section to a maximum distance from the annular housing section adjacent the opening.

27. The laundry drier according to claim 26, wherein the projection includes a front wall at an end of the projection nearest the opening, the front wall defining a projection opening being a secondary outlet opening receiving air flow from the drum and being in fluid flow communication with an outlet channel discharging air flow from the laundry drier.

28. The laundry drier according to claim 26, further comprising a door connected to the housing and being movable between an open condition, in which the door permits access to the drum, and a closed condition, in which the door restricts access to the drum, the door having an additional projection extending inwardly toward the drum and at least partially extending over the opening when the door is in the closed condition.

29. The laundry drier according to claim 26, further comprising a second projection extending radially inwardly from the housing and disposed adjacent the opening for deflecting the laundry away from the opening, the projection and the second projection being disposed on opposite sides of the opening.

30. The laundry drier according to claim 23, further comprising an inlet opening providing air flow to the drum, the opening being an outlet opening receiving air flow from the drum.

31. The laundry drier according to claim 23, further comprising a grid covering the opening.

32. The laundry drier according to claim 31, further comprising a lint filter disposed adjacent the grid.

33. The laundry drier according to claim 23, wherein the projection is disposed before the opening in the principal rotational direction.

34. A laundry drier comprising:
a housing;
a drum supported by the housing for rotation with respect to the housing in a principal rotational direction and forming a drying chamber;
an annular housing section fixed with respect to the housing and surrounding a charging opening providing access to the drum;
an inlet opening providing air flow to the drum;
an outlet opening receiving air flow from the drum; and
a projection connected to the annular housing section and extending radially inwardly from the annular housing section adjacent the outlet opening and before the outlet opening in the principal rotational direction for deflecting the laundry away from the opening.

35. The laundry drier according to claim 34, wherein the projection includes a wedge-shaped body having a guiding wall rising progressively from the annular housing section before the outlet opening in the principal direction of rotation and extending as far as the outlet opening and having a front wall descending steeply from the guiding wall towards the outlet opening, the front wall defining a projection opening being a secondary outlet opening receiving air flow from the drum, the outlet opening and the secondary outlet opening being in fluid flow communication with an outlet channel discharging air flow from the laundry drier.

36. The laundry drier according to claim 34, further comprising a door connected to the housing and being movable between an open condition, in which the door permits access to the drum, and a closed condition, in which the door restricts access to the drum, the door having an additional projection extending inwardly toward the drum and at least partially extending over the opening when the door is in the closed condition.
